(19) United States
(12) Patent Application Publication
(10) Pub. No.: US 2002/0133297 A1
(43) Pub. Date: Sep. 19, 2002

(54) Ligand docking method using evolutionary algorithm

(76) Inventors: Jinn-Moon Yang, Taipei (TW); Cheng-Yan Kao, Taipei (TW)

Correspondence Address: J.C. Patents, Inc., 1340 Reynolds Ave., Suite 114, Irvine, CA, 92614, US

(21) Appl. No.: 09/761,945

(22) Filed: Jan. 17, 2001

(51) Int. Cl. G06G 7/48; G06G 7/58; G06F 19/00

(52) U.S. Cl. 702/19; 703/11

(57) ABSTRACT

A flexible ligand docking method based on evolutionary algorithms is provided. The proposed method incorporates family competition and adaptive rules to integrate decreasing-based mutations and self-adaptive mutations to act as global and local search strategies, respectively. The invention is to provide a method for screening and evaluating conformationally flexible ligands as potential lead compounds, because the method can be applied to search space for possible configurations of ligands in order to correctly dock into the active site of an enzyme. Therefore, the proposed method can be used to guide drug-design strategies and explore evolutionary relationships. Furthermore, the method of this invention has implications for protein engineering and protein folding.

### BACKGROUND OF THE INVENTION

1. Field of Invention

The present invention relates to a method of ligand docking. More particularly, the present invention relates to a method of ligand docking based on evolutionary algorithms for docking conformationally flexible ligands into a rigid macromolecule.

2. Description of Related Art

The docking problem computationally predicts the structures of ligand-protein complexes from the conformations of the flexible ligands and protein molecules. The docking process is an important method for drug design called structure-based drug design that identifies the lead compounds by minimizing the energy of intermolecular interactions. This method has received increasing interest due to the availability of high-resolution structures of macromolecules (such as, enzymes) and the automation of docking processes via a computer-based simulation. With these structures, computer-based methods can be used to identify or design ligands that possess good structural and chemical complementarity to various sites of the macromolecule (enzyme). The combination of molecular structure determination and computation is emerging as an important tool for drug design and discovery. Two essential parts of a docking approach are a scoring function and an efficient algorithm for searching conformation space.

A good scoring function should be able to distinguish a correct binding mode from other putative modes. Different ligands can be bound to a receptor in enormous conformations with varying energies. A scoring function is used to correctly rank the bindings. A variety of scoring methods has been used in molecular docking. In this work, we use an AMBER-type force field function as our scoring function.

The algorithms for automated docking can be divided into two broad categories: matching methods and conformational search methods. The former attempts to find a good docking based on the geometry of a rigid docking molecular and receptor. In this treatment, the enzyme and ligand are taken as rigid objects and the search is reduced to finding energetically or geometrically favorable configurations of the ligand within the active site of the enzyme. Unfortunately, this approach is likely to fail when the bound conformation of the ligand is unknown. Even with rigid-body restriction, the number of possible ligand orientations is enormous, and the computational problem belongs to the class known as NP-complete problem.

A conformational search method is often to dock conformationally flexible ligands by employing a simulation or optimization method to search through the space of ligand-receptor configurations. That is, the ligand is flexible and the receptor is fixed. Generally, these optimization methods, such as simulated annealing and genetic algorithms, have the potential to identify a greater number and variety of known ligands. More recently, evolutionary algorithms become popular in molecule docking applications and perform better than simulated annealing in some applications.

An evolutionary algorithm is a generally adaptable concept for problem solving, especially well suited for solving optimization problems. It bases on ideas borrowed from genetics and natural selection. Evolutionary algorithms have been used to solve problems involving large searching space, where traditional optimization methods are less efficient. They can be applied in varying ways to the confirmation search, structure-based design problems, and protein prediction.

Currently, there are about three main independently developed but strongly related implementations of evolutionary algorithms: genetic algorithms, evolution strategies, and evolutionary programming. For genetic algorithms, both in practice and theory, entail disadvantages of applying binary-represented implementation to the flexible ligand docking. The coding function of binary-represented genetic algorithms may introduce an additional multimodality, making the combined objective function more complex than the original function. To achieve better performance, real-coded genetic algorithms have been introduced. However, they generally employ random-based mutations and hence still require lengthy local searches near a local optima. In contrast, evolution strategies and evolutionary programming mainly use real-valued representation and focus on self-adaptive Gaussian mutations. This type of mutation has succeeded in continuous optimization and has been widely regarded as a good operator for local searches. Unfortunately, experiments show that self-adaptive Gaussian mutation leaves individuals trapped near local optima for rugged functions.

Because none of these three types of original evolutionary algorithms is efficient, many modifications have been proposed to improve solution quality and to speed up convergence. A possible trend is to incorporate local search techniques into evolutionary algorithms. Such a hybrid approach may possess both the global optimality of the genetic algorithms and also the convergence of the local searches. In other words, a hybrid approach usually makes a better tradeoff between computational cost and the global optimality of the solution. However, for those existing methods, local search techniques and genetic operators often work separately during the search process.

### SUMMARY OF THE INVENTION

The invention provides a new ligand docking method called family competition evolutionary algorithm (FCEA) for docking conformationally flexible ligands into a rigid macromolecule. One objective of the invention is to provide a method for screening and evaluating conformationally flexible ligands as potential lead compounds. The proposed method can be applied to search space for possible configurations of known small ligands in order to correctly dock into the active site of an enzyme. Therefore, the proposed method can be used to guide drug-design strategies and explore evolutionary relationships. Furthermore, the method of this invention has implications for protein engineering and protein folding.

As embodied and broadly described herein, FCEA is a multi-operator approach that includes three mutation operators: a decreasing-based Gaussian mutation operator, a self-adaptive Gaussian mutation operator, and a self-adaptive Cauchy mutation operator. It incorporates family competition and adaptive rules for controlling step sizes to construct the relationship among these three operators. In order to balance the search power of exploration and exploitation, each of operators is designed to compensate for the disadvantages of the other. FCEA has been successfully applied to solve global optimization and to train neural networks.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an overview for basic steps of a flexible ligand docking procedure according to one preferred embodiment of this invention;

FIG. 2a is an overview for the processes of the family competition evolutionary algorithm according to one preferred embodiment of this invention;

FIG. 2b is an overview for the processes of the FC-adaptive procedure according to one preferred embodiment of this invention; and

FIG. 3 illustrates density functions of Gaussian and Cauchy distributions.

FIG. 4 illustrating a schematic view of a computerized system for ligand docking.

### DESCRIPTION OF THE PREFERRED EMBODIMENTS

The molecular docking is the molecular recognition between two molecules. In general, the criteria of molecular recognition can be decided by the force field. The recognition process is determined by interactions (including electrostatics) between molecular surfaces, which is a complex event involving molecular flexibility, induced fit, solvent, entropy, hydrophobic, Van der Waals interactions, and electrostatic interactions.

Broadly stated, molecular docking algorithms seek to predict the bound conformations of two interacting molecules, for example, a small ligand and its receptor. The space that can be involved in docking is enormous, particular if a flexible molecule is taken into account. The docking method can be broken down into the following steps: defining the molecule of interest; modeling the molecule (protein) and its interactions with the ligand; and performing the conformational and orientation search to find low-energy states of the system that correlate with the actual binding model.

The molecules of interest can be, for example, proteins, glycoproteins, peptides, polypepetides, oligonucleotides, DNA molecules, RNA molecules or polysaccharides. However, it should be understood that “protein” or “receptor” in this context could represent any possible molecule of interest. Likewise, “ligand” may refer to any target molecule to be docked with the molecule of interest.

The target molecule (ligand) can be selected randomly from a conventional lead compound library, a combinatorial chemical library or provided by the user. The ligand can also be chosen from a SELEX (systematic evolution of ligands by exponential enrichment) processed library. During the preprocessing step, SELEX is used to establish a SELEX processed library for providing ligand sources. The SELEX process allows the simultaneously screening of more than 10¹⁵ individual nucleic acids for different functionalities, and may be simplified to four general steps: (1) generation of a library of potential ligands; (2) binding of the library to the target molecule; (3) partitioning of the bound ligands from the unbound ligands; and (4) amplification of the partitioned ligands to generate a new enriched library. The library of potential ligands includes randomized nucleic acid from genomic dsDNA, randomized nucleic acid from synthesized dsDNA, fragments of genomic dsDNA, RNA transcribed from genomic DNA, or RNA transcribed from cDNA. The SELEX processed library contains molecules that have been selected for high-affinity binding. Therefore, the SELEX processed library has a higher possibility of containing antagonists for any molecule of interest and can provide nucleic-acid type ligands for ligand docking.

Furthermore, the proposed method of the present invention can further include an auxiliary, computer-aided prepossessing step, which simulates the SELEX process to establish a SELEX library.

Once the molecule of interest, “receptor”, is provided, the following step is to define the three-dimensional (3D) structure data of the protein. Preferably, the three-dimensional structure of the receptor or the receptor-binding site is determined empirically through X-ray crystallography and/or nuclear magnetic resonance spectroscopy, and/or obtained from a structural database. Usually, the defined three-dimensional structure data are expressed in forms of three-dimensional coordinates or torsion angles under assumption of constant standard binding geometries.

Two essential parts of the docking method are a scoring (fitness) function and an efficient algorithm.

We adopt an AMBER-type potential function to score the different ligand orientations with the underlying assumption that the correct ligand binding conformation is correspondent to the minimum of this function. For flexible ligand docking, the scoring function must consider the intraligand energy and the interaction energy between the ligand and the receptor. Our scoring function is

Eₜₒₜₐₗ=Eᵢₙₜₑᵣ+Eᵢₙₜᵣₐ (1)

where Eᵢₙₜₑᵣ and Eᵢₙₜᵣₐ are the intermolecular and intramolecular energy respectively. In our scoring function, The Lennard-Jones 6-12 potential function is used to represent the energy of interaction between the ligand and the receptor. The Lennard-Jones equation is given

$${E}_{inter} = {\sum }_{l = 1}^{lig} {\sum }_{r = 1}^{rec} [ \frac{{A}_{lr}}{{r}_{lr}^{12}} - \frac{{B}_{lr}}{{r}_{lr}^{6}} + 332.0 \frac{{q}_{l} {q}_{r}}{ϵ ( {r}_{lr} ) {r}_{lr}} ] \qquad ( 2 )$$

where Aₗᵣ and Bₗᵣ are the nonbonded parameters, ε(rₗᵣ) is the distance-dependent dielectric constant, rₗᵣ is the distance between the atoms l and r, qₗ and qᵣ are the point charges of the atoms in the ligand and receptor respectively, and 332.0 is a factor that converts the electrostatic energy into kilocalories per mole. The lig and rec denote the numbers of the atoms in the ligand and receptor, respectively. In this function, the first and second summation simulates the repulsive and attractive term in Van der Waals interaction energy. The third summation simulates the electrostatic interaction between each pair of atoms. Because we did not include crystal water molecules or add solvent water molecules in our calculations, the distance-dependent dielectric constant (ε(rₗᵣ)=4r) was employed to mimic the solvent effect during the calculations. In our implementation the specific H-bond term was also not considered because we assume that contributions due to hydrogen bonding are included in the electrostatic term.

For the flexible ligand docking, the intramolecular energy of the ligand must be considered, and the energy is

$${E}_{inter} = {\sum }_{{l}^{′} = 1}^{lig} {\sum }_{l = 1}^{{l}^{′} - 1} [ \frac{{A}_{{ll}^{′}}}{{r}_{{ll}^{′}}^{12}} - \frac{{B}_{{ll}^{′}}}{{r}_{{ll}^{′}}^{6}} + 332.0 \frac{{q}_{l} {{q}^{′}}_{l}}{ϵ ( {r}_{{ll}^{′}} ) {r}_{{ll}^{′}}} ] {+ \sum }_{diheds} \frac{{V}_{n}}{2} [ 1 + cos ( n φ - {φ}_{0} ) ] \qquad ( 3 )$$

where the Van der Waals and electrostatic terms are over all of the single bonds, Vₙ is a empirical parameter relating to torsion angle, and φ is the torsion angle of a single bond. The last term is the torsion angle component of the intermolecular energy of the ligand.

AMBER was a well-established scoring function used by previous studies. FCEA can easily adopt other scoring methods, such as the shape scoring method because gradients are not used with FCEA.

Given two molecules that consist of a number of atoms defined by two sets of three-dimensional coordinates, one refers to the ligand molecule and the other refers to the receptor molecule. The basic ligand structure is presumed to be known (i.e. connectivities and positions of the atoms), but the actual binding conformation of the ligand, described by a set of rotatable bonds, is taken as unknown. Both the binding conformation and the orientation of the ligand with the receptor are to be determined. The three-dimensional location and the rotational angles of the ligand relating to the receptor, and the rotatable bonds inside the ligand are adjustable variables. A docking algorithm determines the values of these adjustable variables by minimizing the value of scoring function defined in Eq. (1).

These adjustable variables of a ligand in a particular orientation and conformation space can be represented as

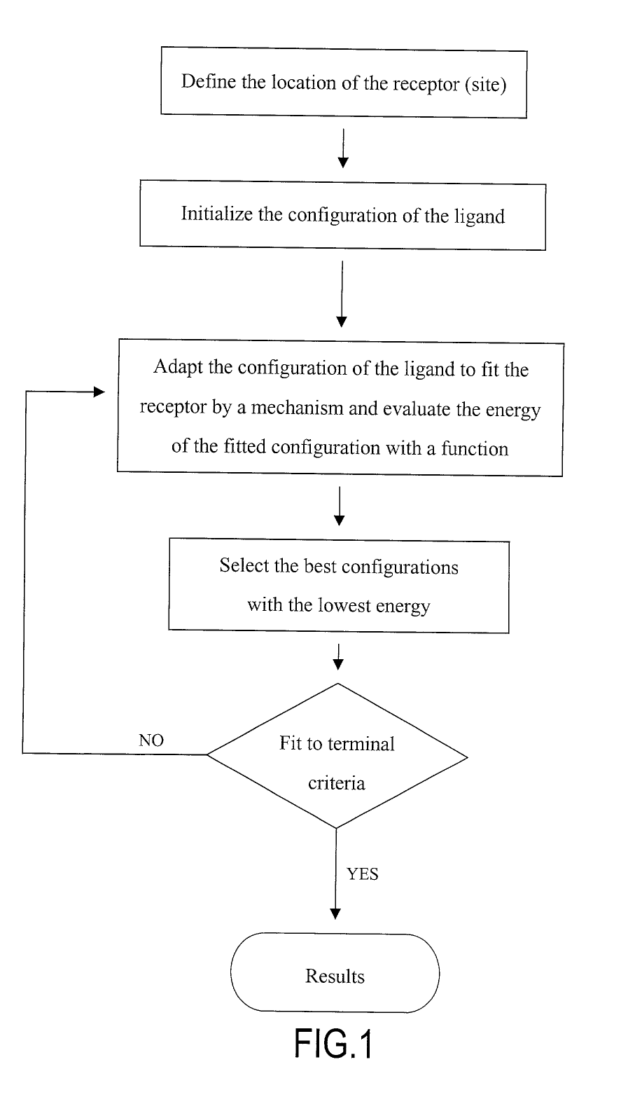

(χ₁ [symbol] χ₂ [symbol] χ₃ [symbol] χ₄ [symbol] χ₅ [symbol] χ₆ [symbol] χ₇ [symbol] . . . [symbol] χₙ) (4)

where n is the number of adjustable variables, χ₁ [symbol] χ₂ and χ₃ represent the 3-dimensional location of the ligand relating to the center of the receptor, χ₄ [symbol] χ₅ and χ₆ are the rotational angles of the ligand relating to axes, and from χ₇ to χₙ are the twisting angles of the rotatable bonds inside the ligand molecule. Generally, the basic steps of the flexible ligand docking procedure (energy minimization procedure) between two molecules can be described briefly as follows and are shown in FIG. 1.

1. Fix and define the location of the receptor site.

2. Initialize the orientation and conformation structure of the ligand molecule, and evaluate the interaction energy based on the scoring function.

3. Adapt the orientation (translating and rotating the ligand molecule) and conformation (twisting the rotatable bonds inside the ligand), to fit the receptor by a mechanism (with a family competition evolutionary algorithm). Evaluate the interaction energy of each new configuration (with a scoring function).

4. Select the best configuration with the lowest interaction energy from these configurations.

5. Repeatedly execute step 3 and step 4 until the terminal criteria are satisfied.

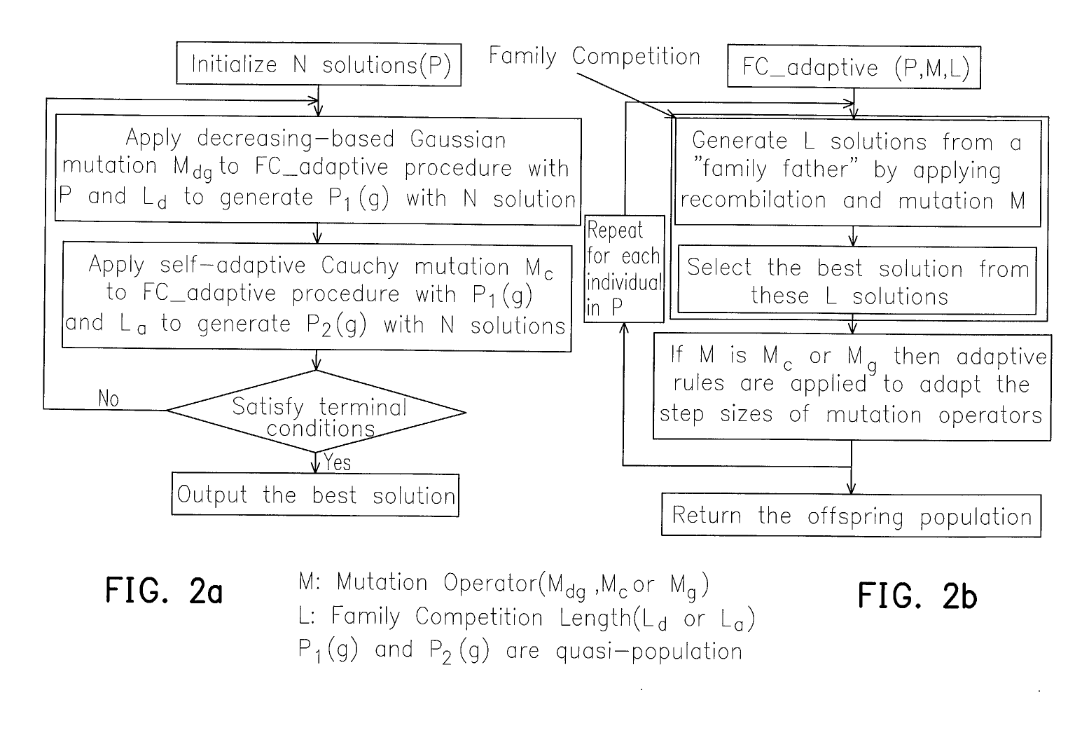

In addition to the binding energy, the existence of hydrogen bonds is another criterion that determines the goodness of fit between molecules. The detail of the family competition evolutionary algorithm (FCEA) for the flexible ligand docking is described here. The basic processes of the FCEA are shown in FIG. 2. N solutions are generated as the initial population. Each solution is represented as a set of four n-dimensional vectors (χ¹ [symbol] σ¹ [symbol] ν¹ [symbol] ψ¹), where n is the number of adjustable variables of the system and i=1, . . . , N. The vector χ shown in Eq. (4) represents the adjustable variables to be optimized; and σ [symbol] ν and ψ are the step-size vectors of decreasing-based mutations, self-adaptive Gaussian mutation, and self-adaptive Cauchy mutation, respectively. In other words, each solution x is associated with some parameters for step-size control. In this paper, the initial χ₁ [symbol] χ₂ and χ₃ are randomly chosen from the feasible box, and the others, from χ₄ to χₙ, are randomly chosen from 0 to 2 π in radians. The initial step sizes σ [symbol] ν and ψ are 0.8, 0.2, 0.2 respectively.

There are three main stages for each iteration of FCEA: decreasing-based Gaussian mutation, self-adaptive Cauchy mutation, and self-adaptive Gaussian mutation. Each stage is realized by generating a new quasi-population (with N solutions) as the parent of the next stage. As shown in FIG. 2, these stages differ only in the mutations used and in some parameters. Hence we use a general procedure “FC-adaptive” to represent the work done by these stages.

The FC-adaptive procedure employs three parameters, namely, the parent population (P, with N solutions), mutation operator (M), and family competition length (L), to generate a new quasi-population. The main work of FC-adaptive is to produce offspring and then conduct the family competition. Each individual in the population sequentially becomes the “family father.” With a probability p_{c}, this family father and another solution that is randomly chosen from the rest of the parent population are used as parents for a recombination operation. Then the new offspring or the family father (if the recombination is not conducted) is operated on by a mutation. For each family father, such a procedure is repeated L times. Finally, L children are produced, but only the one with the lowest objective value survives. Since we create L children from one “family father” and perform a selection, this is a family competition strategy. This method avoids the prematureness but also keeps the spirit of local searches.

After the family competition, there are N parents and N children left. Based on different stages, we employ various ways of obtaining a new quasi-population with N individuals. For both Gaussian and Cauchy self-adaptive mutations, in each pair of father and its best child the one with a better objective value survives. This procedure is called “family selection.” On the other hand, “population selection” chooses the best N individuals from all N parents and N children. With a probability pₚₛ, FCEA applies population selection to speed up the convergence when the decreasing-based Gaussian mutation is used. For the probability (1−pₚₛ), family selection is still considered. In order to reduce the ill effects of greediness on this selection, the initial pₚₛ is set to 0.05, but it is changed to 0.5 when the mean step size of self-adaptive Gaussian mutation is larger than that of decreasing-based Gaussian mutation. Note that the population selection is similar to (μ+μ)-ES in the traditional evolution strategies. Hence, through the process of selection, the FC-adaptive procedure forces each solution of the starting population to have one final offspring. Note that we create LN offspring in the procedure FC-adaptive but the size of the new quasi-population remains the same as N.

For all three mutation operators, we assign different parameters to control their performance. Such parameters must be adjusted through the evolutionary process. We modify them first when mutations are applied. Then after the family competition is complete, parameters are adapted again to better reflect the performance of the whole FC-adaptive procedure.

For easy description of operators, we use a=(μ^{a} [symbol] σ^{a} [symbol] ν^{a} [symbol] ψ^{a}) to represent the “family father” and b=(χ^{b} [symbol] σ^{b} [symbol] ν^{b} [symbol] ψ^{b}) as another parent (only for the recombination operator). The offspring of each operation is represented as c=(χ^{c} [symbol] σ^{c} [symbol] ν^{c} [symbol] ψ^{c}). We also use the symbol χ_{J}^{d} to denote the jth component of an individual d, ∀j ε{1, . . . , n. In the rest of this section we explain each important component of the FC-adaptive procedure: recombination operators, mutation operations, and rules for adapting step sizes (σ [symbol] ν and ψ).

FCEA implements modified discrete recombination and intermediate recombination. Here we would like to mention again that recombination operators are activated with only a probability p_{c}. The adjustable variable χ and a step size are recombined in a recombination operator.

The original discrete recombination generates a child that inherits genes from two parents with equal probability. Here the two parents of the recombination operator are the “family father” and another solution randomly selected. Our experience indicates that FCEA can be more robust if the child inherits genes from the “family father” with a higher probability. Therefore, we modified the operator to be as follows:

$${x}_{j}^{c} = \{ \begin{matrix}{x}_{j}^{a} with possibility 0.8 \\ {x}_{j}^{b} with possibility 0.2\end{matrix} \qquad ( 5 )$$

Intermediate Recombination is defined as:

χ_{J}^{G}=χ_{J}^{a}+(χ_{J}^{b}−χ_{J}^{a})/2 (6)

ω_{J}^{c}=ω_{J}^{a}+β(ωⱼ^{b}−ω_{J}^{a})/2 (7)

where ω is σ [symbol] ν or ψ based on the mutation operator applied in the family competition. For example, if self-adaptive Gaussian mutation is used in this FC-adaptive procedure, (6) is χ and (7) is ν. We follow the work of the evolution strategies community to employ only intermediate recombination on step-size vectors, that is σ [symbol] ν and ψ. To be more precise, χ is also recombined when intermediate recombination is chosen.

Mutations are main operators of FCEA. After the recombination, a mutation operator is applied to the “family father” or the new offspring generated by recombination. In FCEA, the mutation is performed independently on each vector element of the selected child by adding a random value with expectation zero:

χᵢ′=χᵢ+ωD(·) (8)

where χ₁ is the ith component of χ, χ₁′ is the ith component of χ′ mutated from χ, D(·) is a random variable, and w is the step size. In this paper, D(·) is evaluated as N(0,1) or C(1) if the mutations are Gaussian mutation or Cauchy mutation, respectively.

We use self-adaptive Gaussian mutation in global optimization. The mutation is accomplished by first mutating the step size ν_{J} and then mutating the adjustable variable χⱼ:

ν_{J}^{c}=ν_{J}^{a} exp [τ′N(0 1)+τN_{J}(0,1)] (9)

χⱼ^{c}=χⱼ^{a}+ν_{J}^{c}Nⱼ(0,1) (10)

where N(0,1) is the standard normal distribution. N_{J}(0,1) is a new value with distribution N(0,1) that must be regenerated for each index j. For FCEA, we follow in setting τ and τ′ as (\sqrt{2n−1})⁻¹ and (\sqrt{2n}) ⁻¹ respectively.

We define self-adaptive Cauchy mutation as follows:

ψ_{J}^{c}=ψ_{J}^{a} exp [τ′N(0,1)+τN_{J}(0,1)] (11)

χ_{J}^{c}=χ_{J}^{a}+ψ_{J}^{c}C_{J}(t) (12)

In our experiments, t is 1. Note that self-adaptive Cauchy mutation is similar to self-adaptive Gaussian mutation except that (10) is replaced by (12). That is, they implement the same step-size control but use different means of updating χ.

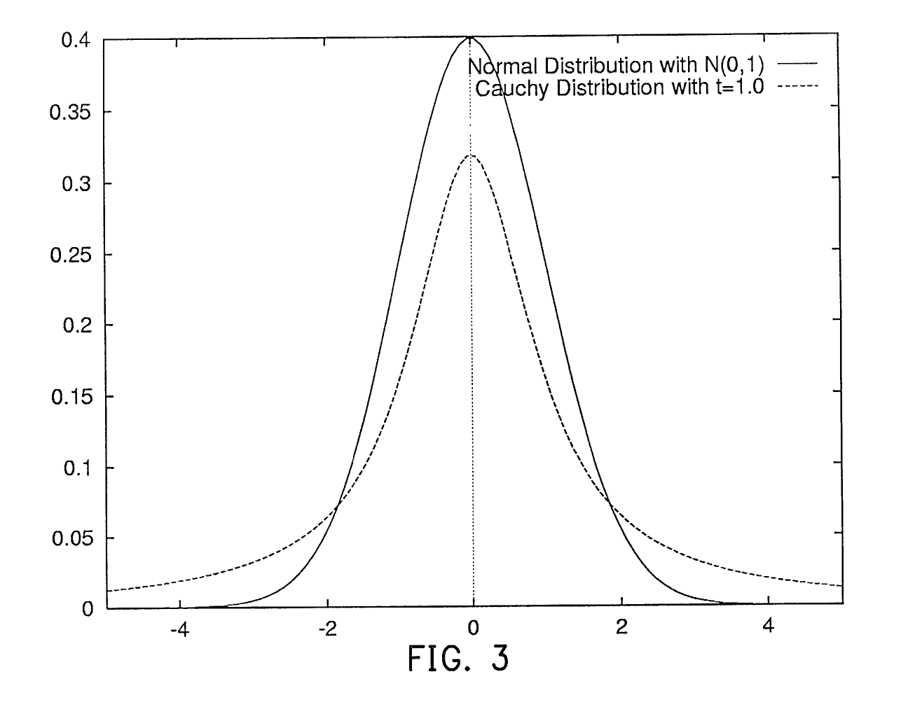

FIG. 3 compares density functions of Gaussian distribution [N(0,1)] and Cauchy distributions [C(1)]. Clearly Cauchy mutation is able to make a larger perturbation than Gaussian mutation. This implies that Cauchy mutation has a higher probability of escaping from local optima than Gaussian mutation.

Our decreasing-based Gaussian mutation uses the step-size vector σ with a fixed decreasing rate γ=0.95 as follows:

σ^{c}=γσ^{a} (13)

χ_{J}^{c}=χⱼ^{a}+σ^{c}N_{J}(0,1) (14)

Previous results demonstrated that self-adaptive mutations converge faster than decreasing-based mutations but, for rugged functions, self-adaptive mutations more easily trap into local optima than decreasing-based mutations.

The performance of Gaussian and Cauchy mutations is largely influenced by the step sizes. FCEA adjusts the step sizes while mutations are applied [e.g. (9), (11) and (13)]. However, such updates insufficiently consider the performance of the whole family. Therefore, after family competition, some additional rules are implemented:

1. A-decrease-rule: Immediately after self-adaptive mutations, if objective values of all offspring are greater than or equal to that of the “family parent,” we decrease the step-size vectors ν (Gaussian) or ψ (Cauchy) of the parent:

ω_{J}^{a}=0.95ω_{J}^{a} (15)

where ω^{a} is the step size vector of the parent. In other words, when there is no improvement after self-adaptive mutations, we may propose applying a more conservative, that is, smaller step size in the next iteration. This follows from the ⅕-success rule of (1+\λ)-ES.

2. D-increase-rule: It is difficult, however, to decide the rate γ of decreasing-based mutations. Unlike self-adaptive mutations that adjust step sizes automatically, the step size of decreasing-based mutation goes to zero as the number of iteration increases. Therefore, it is essential to employ a rule that can enlarge the step size in some situations. The step size of the decreasing-based mutation should not be too small, when compared to step sizes of self-adaptive mutations. Here, we propose to increase σ if one of the two self-adaptive mutations generates a better offspring. To be more precise, if after a self-adaptive mutation, the best child with step size ν is better than its “family father,” then the step size of the decreasing-based mutation is updated as follows:

σ^{c}=max(σ^{c},βνₘₑₐₙ^{c}) (16)

where νₘₑₐₙ^{c} is the mean value of the vector ν; and β is 0.2 in our experiments. Note that this rule is applied in stages of self-adaptive mutations but not of decreasing-based mutations.

Modifications to these formulation may be necessary for implementing various functions. The nature and implementation of such modifications are apparent to persons skilled in the prior art and within the scope of the present invention.

TABLE I

| Parameter Name | Value of Parameters |
|---|---|
| Population size | 50 |
| Recombination rate | Pc = 0.3 |
| Probability of the | Pcd = 0.8 (discrete recombination) |
| Recombination Operator | Pci = 0.2 (intermediate recombination) |
| Family competition Length | Ld = 3 (length in decreasing-based stage) |
| | La = 6 (length in two adaptive stages) |
| Step Sizes | σ = 0.8 and υ = ψ = 0.2 |

Table I indicates an example of the settings of FCEA parameters, such as family competition lengths and crossover rates. L_{d} and σ are the parameters for the decreasing-based mutation; Lₐ [symbol] ν and ψ are for self-adaptive mutations. The population size is 50. FCEA stops if it exceeds a maximal number of generations, or FCEA is unable to find the better solution to reduce the energy in one generation. Preferably, the maximal number of generation is set to 250. For example, FCEA tests each docking problem with 20 independent runs. FCEA needs 187,500 evaluations for each run because it requires 750 evaluations in one generation.

The present invention is to provide a method for screening and evaluating conformationally flexible ligands as potential lead compounds. The proposed method can be applied to search space for possible configurations of known ligands in order to correctly dock into the active site of a receptor. Therefore, the proposed method can be used to guide drug-design strategies and explore evolutionary relationships. Furthermore, the principles of this invention may be modified and have further implications for protein engineering and protein folding prediction.

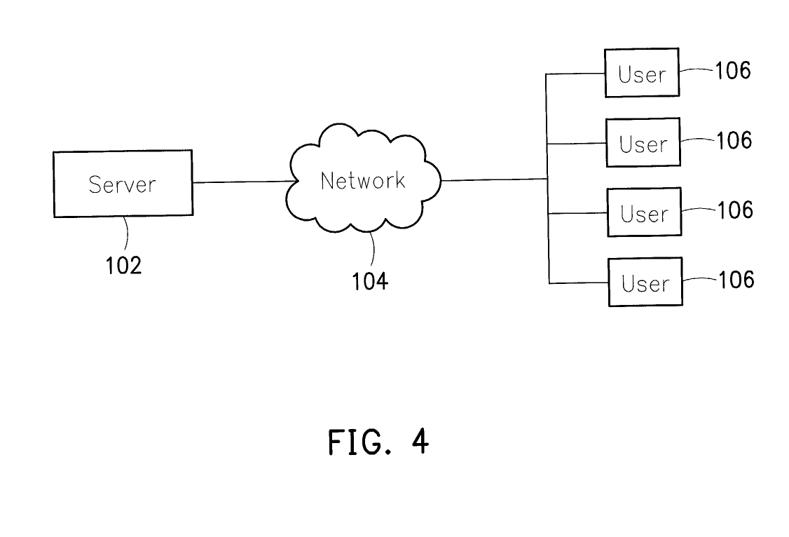

The docking method of the present invention, as described in the previous sections, can be used in a computerized system for docking flexible ligands to rigid macromolecules. As shown in FIG. 4, the computerized system 100 that applies the docking method for docking flexible ligands can be an open system including a server 102. The server 102 includes means for storing. The server 102 is accessible over a computer network 104 by other authorized users 106 for either providing initial data resources or inputting commands. The server 102 can output the final data resources over the computer network 104 back to the authorized users 106 based on the commands. The means for transferring the data resources and the commands (either inputting or outputting) can be, for example, TC/PIP. However, every possible means for transferring the data resources and the commands available at the time is within the scope of the invention. On the other hand, the computerized system can be a close system running the docking method.

Furthermore, the method of docking flexible ligands can be configured as a computer readable program. Persons skilled in the relevant art will be able to produce such computer readable program based on the discussion of the proposed method contained herein.

The exemplary embodiments have been primarily described with reference to flow charts illustrating pertinent features of the embodiments. Each method step may also represent a hardware or software component for performing the corresponding step. It should be appreciated that not all components or method steps of a complete implementation of a practical system are necessarily illustrated or described in detail. Rather, only those components or method steps necessary for a thorough understanding of the invention have been illustrated and described in detail. Actual implementations may utilize more steps or components or fewer steps or components.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of ligand docking based on evolutionary algorithms for docking a conformationally flexible ligand to a rigid molecule, the method comprising:
defining a conformation of the rigid molecule by three-dimensional coordinates of atoms of the molecule;
choosing randomly a first configuration and orientation of the ligand relative to the molecule;
applying a family competition evolutionary algorithm with a scoring function to the first configuration and orientation of the ligand relative to the molecule, wherein applying the family competition evolutionary algorithm includes at least three sequential stages of applying a decreasing-based Gaussian mutation operator, applying a self-adaptive Cauchy mutation operator and applying a self-adaptive Gaussian mutation operator; and
obtaining a second configuration and orientation of the ligand relative to the molecule with a minimum energy.

2. The method as claimed in claim 1, wherein each configuration and orientation of the ligand is defined by a set of variables, which variables are applied to the scoring function in order to obtain a value correspondent to an energy of the ligand orientation, and wherein the energy includes an intramolecular energy of the ligand and an interaction energy between the ligand and the molecule.

3. The method as claimed in claim 1, wherein each of the mutation operators has a family competition length of a value L, so that L sets of variables are obtained after applying the mutation operator L times, and wherein each set of variables are applied to the force field function in order to obtain an energy value, while only one set of variables with a lowest energy value is selected.

4. The method as claimed in claim 2, wherein a formulation used for calculating the interaction energy between the ligand and the molecule comprises:
$${E}_{inter} = {\sum }_{l = 1}^{lig} {\sum }_{r = 1}^{rec} [ \frac{{A}_{lr}}{{r}_{lr}^{12}} - \frac{{B}_{lr}}{{r}_{lr}^{6}} + 332.0 \frac{{q}_{l} {q}_{r}}{ϵ ( {r}_{lr} ) {r}_{lr}} ] ,$$
, wherein Aₗᵣ and Bₗᵣ are nonbonded parameters; ε(rₗᵣ) is a distance-dependent dielectric constant, rₗᵣ is a distance between atoms l and r; qₗ and qᵣ are point charges of the atoms in the ligand and molecule respectively; and lig and rec denote numbers of the atoms in the ligand and molecular (receptor) respectively.

5. The method as claimed in claim 2, wherein a formulation used for calculating the intramolecular energy of the ligand comprises:
$${E}_{inter} = {\sum }_{{l}^{′} = 1}^{lig} {\sum }_{l = 1}^{{l}^{′} - 1} [ \frac{{A}_{{ll}^{′}}}{{r}_{{ll}^{′}}^{12}} - \frac{{B}_{{ll}^{′}}}{{r}_{{ll}^{′}}^{6}} + 332.0 \frac{{q}_{l} {{q}^{′}}_{l}}{ϵ ( {r}_{{ll}^{′}} ) {r}_{{ll}^{′}}} ] + {\sum }_{diheds} \frac{{V}_{n}}{2} [ 1 + cos ( n φ - {φ}_{0} ) ] ,$$
, wherein Vₙ is a empirical parameter relating to a torsion angle, and φ is the torsion angle of a single bond.

6. The method as claimed in claim 2, wherein the set of variables can be represented as
(χ₁ [symbol] χ₂ [symbol] χ₃ [symbol] χ₄ [symbol] χ₅ [symbol] χ₆ [symbol] χ₇ [symbol] . . . [symbol] χₙ)
where n is the number of adjustable variables, χ₁ [symbol] χ₂ and χ₃ represent the 3-dimensional location of the ligand relating to the center of the receptor, χ₄ [symbol] χ₅ and χ₆ are the rotational angles of the ligand relating to axes, and from χ₇ to χₙ are the twisting angles of the rotatable bonds inside the ligand molecule.

7. The method as claimed in claim 1, wherein formulations used for the decreasing-based Gaussian mutation operator comprise:
σ^{c}=γσ^{a}
χ_{J}^{c}=χ_{J}^{a}+σ^{c}N_{J}(0,1)
, wherein χ_{J}^{c} is the jth component of the variable χ mutated from χⱼ^{a}; σ^{c} is the step-size vector mutated from σ^{a}; N(0,1) is the standard normal distribution; Nⱼ(0,1) is a new value with distribution N(0,1) that must be regenerated for each index j; and a decreasing rate γ is 0.95.

8. The method as claimed in claim 1, wherein formulations of the self-adaptive Cauchy mutation operator comprise:
ψ_{J}^{c}=ψ_{J}^{a} exp [τ′N(0,1)+τN_{J}(0,1)]
χⱼ^{c}=χ_{J}^{a}+ψ_{J}^{c}C_{J}(t)
, wherein χ_{J}^{c} is the jth component of the variable χ mutated from χ_{J}^{a}; ψ_{J}^{c} is the jth component of the step size for the self-adaptive Cauchy mutation operator mutated from ψ_{J}^{a}; N(0,1) is the standard normal distribution; N_{J}(0,1) is a new value with distribution N(0,1) that must be regenerated for each index j; and t [symbol] τ and τ′ are 1, (\sqrt{2n−1})⁻¹ and (\sqrt{2n})⁻¹ respectively.

9. The method as claimed in claim 1, wherein formulations used for the self-adaptive Gaussian mutation operator comprise:
ν_{J}^{c}=νⱼ^{a} exp [τ′N(0,1)+τNⱼ(0,1)]
χ_{J}^{c}=χ_{J}^{a}+ν_{J}^{c}Nⱼ(0,1)
, wherein χ_{J}^{c} is the jth component of the variable χ mutated from χ_{J}^{a}; ν_{J}^{c} is the jth component of the step size for the self-adaptive Gaussian mutation operator mutated from ν_{J}^{a}; N(0,1) is the standard normal distribution; N_{J}(0,1) is a new value with distribution N(0,1) that must be regenerated for each index j; and τ and τ′are (\sqrt{2n−1})⁻¹ and (√2\sqrt{n})⁻¹ respectively.

10. The method as claimed in claim 1, wherein a recombination operator can further be implemented to combine two different sets of variables with a probability P_{c} before applying the mutation operator.

11. The method as claimed in claim 1, wherein the method of ligand docking can be configured as a computer readable program performed in a computerized system, which system can be accessed over a computer network from a source address with an authorization code.

12. A computerized ligand docking system for docking a conformationally flexible ligand to a rigid molecule, which can be accessed over a computer network from a source address with an authorization code, the system comprising:
means for inputting commands;
means for storing;
means for defining a conformation of the rigid molecule by three-dimensional coordinates of atoms of the molecule;
means for choosing randomly a first configuration and orientation of the ligand relative to the molecule;
means for applying a family competition evolutionary algorithm with a scoring function to the first configuration and orientation of the ligand relative to the molecule, wherein applying the family competition evolutionary algorithm includes at least three sequential stages of applying a decreasing-based Gaussian mutation operator, applying a self-adaptive Cauchy mutation operator and applying a self-adaptive Gaussian mutation operator;
means for obtaining a second configuration and orientation of the ligand relative to the molecule with a minimum energy; and
means for output the second configuration and orientation of the ligand relative to the molecule with the minimum energy based on the commands.

13. The system as claimed in claim 12, wherein each configuration and orientation of the ligand is defined by a set of variables, which variables are applied to the scoring function in order to obtain a value correspondent to an energy of the ligand orientation, and wherein the energy includes an intramolecular energy of the ligand and an interaction energy between the ligand and the molecule.

14. The system as claimed in claim 12, wherein each of the mutation operators has a family competition length of a value L, so that L sets of variables are obtained after applying the mutation operator L times, and wherein each set of variables are applied to the scoring function in order to obtain an energy value, while only one set of variables with a lowest energy value is selected.

15. The system as claimed in claim 13, wherein a formulation used for calculating the interaction energy between the ligand and the molecule comprises:
$${E}_{inter} = {\sum }_{l = 1}^{lig} {\sum }_{r = 1}^{rec} [ \frac{{A}_{lr}}{{r}_{lr}^{12}} - \frac{{B}_{lr}}{{r}_{lr}^{6}} + 332.0 \frac{{q}_{l} {q}_{r}}{ϵ ( {r}_{lr} ) {r}_{lr}} ] ,$$
, wherein Aₗᵣ and Bₗᵣ are nonbonded parameters; ε(rₗᵣ) is a distance-dependent dielectric constant, rₗᵣ is a distance between atoms l and r; qₗ and qᵣ are point charges of the atoms in the ligand and molecule respectively; and lig and rec denote numbers of the atoms in the ligand and molecular (receptor) respectively.

16. The system as claimed in claim 13, wherein a formulation used for calculating the intramolecular energy of the ligand comprises:
$${E}_{inter} = {\sum }_{{l}^{′} = 1}^{lig} {\sum }_{l = 1}^{{l}^{′} - 1} [ \frac{{A}_{{ll}^{′}}}{{r}_{{ll}^{′}}^{12}} - \frac{{B}_{{ll}^{′}}}{{r}_{{ll}^{′}}^{6}} + 332.0 \frac{{q}_{l} {{q}^{′}}_{l}}{ϵ ( {r}_{{ll}^{′}} ) {r}_{{ll}^{′}}} ] + {\sum }_{diheds} \frac{{V}_{n}}{2} [ 1 + cos ( n φ - {φ}_{0} ) ] ,$$
, wherein Vₙ is a empirical parameter relating to a torsion angle, and φ is the torsion angle of a single bond.

17. The system as claimed in claim 13, wherein the set of variables can be represented as
(χ₁ [symbol] χ₂ [symbol] χ₃ [symbol] χ₄ [symbol] χ₅ [symbol] χ₆ [symbol] χ₇ [symbol] . . . [symbol] χₙ)
where n is the number of adjustable variables, χ₁ [symbol] χ₂ and χ₃ represent the 3-dimensional location of the ligand relating to the center of the receptor, χ₄ [symbol] χ₅ and χ₆ are the rotational angles of the ligand relating to axes, and from χ₇ to χₙ are the twisting angles of the rotatable bonds inside the ligand molecule.

18. The system as claimed in claim 12, wherein formulations used for the decreasing-based Gaussian mutation operator comprise:
σ^{c}=γσ^{a}
χ_{J}^{c}=χ_{J}^{a}+σ^{c}N_{J}(0,1)
, wherein χ_{J}^{c} is the jth component of the variable χ mutated from χ_{J}^{a}; σ^{c} is the step-size vector mutated from σ^{a}; N(0,1) is the standard normal distribution; Nⱼ(0,1) is a new value with distribution N(0,1) that must be regenerated for each index j; and a decreasing rate γ is 0.95.

19. The system as claimed in claim 12, wherein formulations of the self-adaptive Cauchy mutation operator comprise:
ψ_{J}^{c}=ψ_{J}^{a} exp [τ′N(0,1 )+τN_{J}(0,1)]
χ_{J}^{c}=χ_{J}^{a}+ψ_{J}^{c}C_{J}(t)
, wherein χ_{J}^{c} is the jth component of the variable χ mutated from χ_{J}^{a}; ψ_{J}^{c} is the jth component of the step size for the self-adaptive Cauchy mutation operator mutated from ψ_{J}^{a}; N(0,1) is the standard normal distribution; Nⱼ(0,1) is a new value with distribution N(0,1) that must be regenerated for each index j; and t [symbol] τ and τ′ are 1, (\sqrt{2n−1})⁻¹ and (\sqrt{2n})⁻¹ respectively.

20. The system as claimed in claim 12, wherein formulations used for the self-adaptive Gaussian mutation operator comprise:
ν_{J}^{c}=ν_{J}^{a} exp [τ′N(0,1)+τN_{J}(0,1)]
χ_{J}^{c}=χ_{J}^{a}+ν_{J}^{c}N_{J}(0,1)
, wherein χ_{J}^{c} is the jth component of the variable χ mutated from χ_{J}^{a}; ν_{J}^{c} is the jth component of the step size for the self-adaptive Gaussian mutation operator mutated from ν_{J}^{a}; N(0,1) is the standard normal distribution; N_{J}(0,1) is a new value with distribution N(0,1) that must be regenerated for each index j; and τ and τ′are (\sqrt{2n−1})⁻¹ and (\sqrt{2n})⁻¹ respectively.

21. The system as claimed in claim 12, wherein a recombination operator can further be implemented to combine two different sets of variables with a probability P_{c} before applying the mutation operator.

22. A storage system comprises an operating program, wherein the program includes instructions for causing the system to:
define a conformation of the rigid molecule by three-dimensional coordinates of atoms of the molecule;
choose randomly a first configuration and orientation of the ligand relative to the molecule;
apply a family competition evolutionary algorithm with a scoring function to the first configuration and orientation of the ligand relative to the molecule, wherein applying the family competition evolutionary algorithm includes at least three sequential stages of applying a decreasing-based Gaussian mutation operator, applying a self-adaptive Cauchy mutation operator and applying a self-adaptive Gaussian mutation operator;
obtain a second configuration and orientation of the ligand relative to the molecule with a minimum energy,
wherein each configuration and orientation of the ligand is defined by a set of variables, which variables are applied to the scoring function in order to obtain a value correspondent to an energy of the ligand orientation,
wherein the energy includes an intramolecular energy of the ligand and an interaction energy between the ligand and the molecule,
wherein a recombination operator can further be implemented to combine two different sets of variables with a probability P_{c} before applying the mutation operator,
wherein each of the mutation operators has a family competition length of a value L, so that L sets of variables are obtained after applying the mutation operator L times,
and wherein each set of variables are applied to the scoring function in order to obtain an energy value, while only one set of variables with a lowest energy value is selected.

23. The system as claimed in claim 22, wherein a formulation used for calculating the interaction energy between the ligand and the molecule comprises:
$${E}_{inter} = {\sum }_{l = 1}^{lig} {\sum }_{r = 1}^{rec} [ \frac{{A}_{lr}}{{r}_{lr}^{12}} - \frac{{B}_{lr}}{{r}_{lr}^{6}} + 332.0 \frac{{q}_{l} {q}_{r}}{ϵ ( {r}_{lr} ) {r}_{lr}} ] ,$$
, wherein Aₗᵣ and Bₗᵣ are nonbonded parameters; ε(rₗᵣ) is a distance-dependent dielectric constant, rₗᵣ is a distance between atoms l and r; qₗ and qᵣ are point charges of the atoms in the ligand and molecule respectively; and lig and rec denote numbers of the atoms in the ligand and molecular (receptor) respectively.

24. The system as claimed in claim 22, wherein a formulation used for calculating the intramolecular energy of the ligand comprises:
$${E}_{inter} = {\sum }_{{l}^{′} = 1}^{lig} {\sum }_{l = 1}^{{l}^{′} - 1} [ \frac{{A}_{{ll}^{′}}}{{r}_{{ll}^{′}}^{12}} - \frac{{B}_{{ll}^{′}}}{{r}_{{ll}^{′}}^{6}} + 332.0 \frac{{q}_{l} {{q}^{′}}_{l}}{ϵ ( {r}_{{ll}^{′}} ) {r}_{{ll}^{′}}} ] + {\sum }_{diheds} \frac{{V}_{n}}{2} [ 1 + cos ( n φ - {φ}_{0} ) ] ,$$
, wherein Vₙ is a empirical parameter relating to a torsion angle, and φ is the torsion angle of a single bond.

25. The method as claimed in claim 22, wherein the set of variables can be represented as
(χ₁ [symbol] χ₂ [symbol] χ₃ [symbol] χ₄ [symbol] χ₅ [symbol] χ₆ [symbol] χ₇ [symbol] . . . [symbol] χₙ)
where n is the number of adjustable variables, χ₁ [symbol] χ₂ and χ₃ represent the 3-dimensional location of the ligand relating to the center of the receptor, χ₄ [symbol] χ₅ and χ₆ are the rotational angles of the ligand relating to axes, and from χ₇ to χₙ are the twisting angles of the rotatable bonds inside the ligand molecule.

26. The method as claimed in claim 22, wherein formulations used for the decreasing-based Gaussian mutation operator comprise:
σ^{c}=γσ^{a}
χ_{J}^{c}=χ_{J}^{a}+σ^{c}Nⱼ(0,1)
, wherein χ_{J}^{c} is the jth component of the variable χ mutated from χ_{J}^{a}; σ^{c} is the step-size vector mutated from σ^{a}; N(0,1) is the standard normal distribution; N_{J}(0,1) is a new value with distribution N(0,1) that must be regenerated for each index j; and a decreasing rate γ is 0.95.

27. The method as claimed in claim 22, wherein formulations of the self-adaptive Cauchy mutation operator comprise:
ψ_{J}^{c}=ψ_{J}^{a} exp [τ′N(0,1)+τN_{J}(0,1)]
χ_{J}^{c}=χ_{J}^{a}+ψ_{J}^{c}C_{J}(t)
, wherein χ_{J}^{c} is the jth component of the variable χ mutated from χ_{J}^{a}; ψ_{J}^{c} is the jth component of the step size for the self-adaptive Cauchy mutation operator mutated from ψ_{J}^{a}; N(0,1) is the standard normal distribution; Nⱼ(0,1) is a new value with distribution N(0,1) that must be regenerated for each index j; and t [symbol] τ and τ′ are 1, (\sqrt{2n−1})⁻¹ and (\sqrt{2n})⁻¹ respectively.

28. The method as claimed in claim 22, wherein formulations used for the self-adaptive Gaussian mutation operator comprise:
ν_{J}^{c}=ν_{J}^{a} exp [τ′N(0,1)+τN_{J}(0,1)]
χ_{J}^{c}=χ_{J}^{a}+ν_{J}^{c}N_{J}(0,1)
, wherein χ_{J}^{c} is the jth component of the variable χ mutated from χ_{J}^{a}; ν_{J}^{c} is the jth component of the step size for the self-adaptive Gaussian mutation operator mutated from ν_{J}^{a}; N(0,1) is the standard normal distribution; Nⱼ(0,1) is a new value with distribution N(0,1) that must be regenerated for each index j; and τ and τ′are (\sqrt{2n−1})⁻¹ and (\sqrt{2n})⁻¹ respectively.
